(19) United States
(12) Patent Application Publication
(10) Pub. No.: US 2010/0103169 A1
(43) Pub. Date: Apr. 29, 2010

(54) METHOD OF REBUILDING 3D SURFACE MODEL

(75) Inventors: Wen-Xing Zhang, Changhua County (TW); I-Chen Lin, Taipei City (TW); Jia-Ru Lin, Taipei County (TW); Shian-Jun Chiou, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/350,242

(22) Filed: Jan. 8, 2009

(30) Foreign Application Priority Data
Oct. 29, 2008 (TW) 97141640

(51) Int. Cl. G06T 17/10

(52) U.S. Cl. 345/420

(57) ABSTRACT

A method of rebuilding a 3D surface model is provided herein. The method includes the following steps: obtaining a 3D position and the reflectance parameters corresponding to an object according to the structured light system; building a synthesized image according to the 3D position and the reflectance parameters; then, optimizing the reflectance parameters for the synthesized image until the cost functions are smaller than a predetermined value. The invention presents an optimization algorithm to simultaneously estimate both a 3D shape and the parameters of a surface reflectance model from real objects.

### CROSS-REFERENCE TO RELATED APPLICATION

This application claims the priority benefit of Taiwan application serial no. 97141640, filed on Oct. 29, 2008. The entirety of the above-mentioned patent application is hereby incorporated by reference herein and made a part of specification.

### BACKGROUND OF THE INVENTION

1. Field of the Invention

The present invention relates to a method of rebuilding a 3D surface model, specifically to a method of rebuilding a 3D surface model regarding a translucent object and a specular object.

2. Description of Related Art

In recent years, due to the development of stereo television and computer animation, the 3D scan rebuilding model technique has been widely used in numerous applications such as computer graphics or computer visions. Basically, the 3D scan rebuilding model technique is categorized into the following types: passive stereo, active stereo, shape from shading, and photometric stereo.

Among these, the passive stereo rebuilding method utilizes cross validation of a plurality of real object images from different viewing angles, and uses trigonometry to calculate the 3D surface of the real object. The main advantages of the passive stereo rebuilding method are simple implementation and the fact that only two or more cameras are required to complete the process. However, at the parts with less texture, the comparison of corresponding points is not easy, so the accuracy of these parts would be lower.

The active stereo rebuilding method then uses an extra light source or a laser projector to scan the object for rebuilding the 3D image. Comparing to the passive stereo rebuilding method, the active stereo rebuilding method has an easier calculation for the corresponding points in the image, and the image accuracy is also higher. However, from another perspective, the system for the active stereo rebuilding method usually requires an extra projection device, and results in heavier weight and a higher cost. Besides, as the detail parts of the 3D image of a non-lambertian surface object calculated by the passive or active stereo rebuilding method is rougher than the detail parts of the real image of the object, and the calculation process does not include the effect of the reflection property on the image. Therefore, the 3D image of a non-lambertian surface object may not be calculated by the passive or the active stereo rebuilding method.

The lambertian surface aforementioned is defined by the following properties. When the lambertian surface and a surface normal vector are fixed and all the observation directions represent the same brightness, then the brightness is a constant unrelated to the observation directions. However, practically, other than the lambertian reflection property, most objects in the world obtain a specular reflection or a subsurface scattering property.

The shape from shading method and the photometric stereo method utilize the information from the reflection intensity change to rebuild the 3D stereo image configuration of the object. The photometric stereo method usually illuminates in a plurality of directions and observes the change in reflection intensity of the object from an observation angle in a single direction. Moreover, the calculation process usually uses the lambertian model; that is, assuming the object as a lambertian surface object, so the prediction of a normal vector becomes a simple linear least-square problem.

However, as not all real objects have only lambertian reflection properties, the traditional photometric stereo method has a greater inaccuracy for the objects containing the specular material. On the contrary, the photometric stereo method uses the change of intensity of a single image and a given illumination condition to rebuild the 3D stereo surface. However, the formation of a range image by the photometric stereo method would be affected by an interference input or a simplified reflection model and result in the interference in the rebuilt image.

Therefore, the conventional 3D rebuilding model techniques are limited by the geometric information of the detail parts of the object that the scanning system is unable to provide. As a consequence, the resolution of the 3D geometric image of the object is also limited. In addition, the conventional techniques can not process an object with the specular reflection property, or the partial translucent material formed by a plurality of layered structures as a component of the object, i.e., an object with the sub-surface scattering property.

### SUMMARY OF THE INVENTION

Accordingly, the present invention provides a method of rebuilding a 3D surface model. The method rebuilds objects with a partial specular material property or a partial translucent property.

In addition, the present invention provides another method for rebuilding a 3D surface model parameter that combines consideration of the specular material part or the partial translucent material part of the object, and further synthesizing a synthesized image with a specular reflection property and a subsurface scattering property.

To achieve the above and other objectives, the present invention provides a method of rebuilding a 3D surface model. The method includes the following steps: obtaining a 3D position of the object and a plurality of reflectance parameters corresponding to the object according to a structured light system; building synthesized image according to the 3D position and the plurality of reflectance parameters; then, optimizing the reflectance parameters for the synthesized image until a cost function is smaller than a predetermined value.

Here, the cost function corresponds to a difference between an intensity of a plurality of pixels in relative positions of the synthesized image and an intensity of a plurality of pixels of a real image.

In one embodiment of the present invention, the cost functions include a first term and a second term. Here, the first term corresponds to a square of a difference between an intensity of pixels in the synthesized image and an intensity of the corresponding pixels in a real image. The second term corresponds to a difference between a depth of each of the pixels in the synthesized image and a depth of a plurality of corresponding peripheral pixels.

In one embodiment of the present invention, an equation for the cost function is represented as follows:

$$C ( Z ) = {\sum }_{i = 1}^{n} [ {( {S}^{i} - {R}^{i} )}^{2} + w {\sum }_{j = 1}^{m} {( {r}_{j} - {z}_{i} )}^{2} ]$$

Herein, C(Z) represents a cost function; Sⁱ represents an intensity of pixels in a synthesized image; Rⁱ represents an intensity of pixels in a real image; zᵢ represents a depth of pixels in the synthesized image; rⱼ represents a depth of pixels corresponding to a plurality of peripheral pixels of zᵢ; n represents a total pixel number in the synthesized image; m represents a total pixel number of the plurality of peripheral pixels; i represents an index value of the pixels in the synthesized image; j represents an index value of peripheral pixels; w represents a weight value of the second term in the cost function.

In one embodiment of the present invention, the steps of obtaining the 3D position and a plurality of reflectance parameters corresponding to the object according to the 3D structured light system further include using a lambertian reflectance model and a shape from shading technique to acquire the 3D position of the object and initial values of the plurality of reflectance parameters.

In one embodiment of the present invention, the reflectance parameters aforementioned include at least one of a scattering coefficient and a normal vector.

In one embodiment of the present invention, the step of building the synthesized image according to the 3D position and the reflectance parameters further includes using a specular material model and the reflectance parameters to build the synthesized image. Here, the reflectance parameters include the scattering coefficient, a specular coefficient, and a shininess coefficient.

In one embodiment of the present invention, the specular material model aforementioned is a Phong model, of which an equation is represented as:

Sᵢ=k_{d}*Nᵢ·L+kₛ*(Fᵢ·V)^{α}

Herein, Sᵢ is an pixel intensity; k_{d} is a scattering coefficient; kₛ is a specular coefficient; Nᵢ is a surface normal vector, which may be acquired by the slope of an adjacent zᵢ; L is an incident light vector, Fᵢ is a total specular reflection vector, which is acquired through Nᵢ and L; V is a viewing angle vector; α is the shininess coefficient.

In one embodiment of the present invention, the step of following and reflecting the depth information for rebuilding the reflection model further includes using a translucent material model and the reflectance parameters to build the synthesized image. Herein, the reflectance parameters include the scattering coefficient, an absorption coefficient and a refractive index.

In one embodiment of the present invention, the translucent material model aforementioned is a bidirectional subsurface scattering reflection distribution function (BSSRDF); an equation is represented as:

$${S}_{d} ( {x}_{i} , {\vec{ω}}_{i} , {x}_{o} , {\vec{ω}}_{o} ) = \frac{1}{π} {F}_{t} ( {x}_{i} , {\vec{ω}}_{i} ) {P}_{d} ( {‖ {x}_{i} - {x}_{o} ‖}_{2} ) {F}_{t} ( {x}_{o} , {\vec{ω}}_{o} )$$

Herein, S_{d} is an pixel intensity; Fₜ is a Fresnel conversion function; xᵢ is an incident position of a light entering an object; xₒ is a refractive position of a light leaving an object; \vec{ω}ᵢ is an incident angle; \vec{ω}ₒ is a refractive angle; P_{d} is a scattering quantitative change curve function.

In one embodiment of the present invention, the step of optimizing the reflectance parameters and optimizing the synthesized image repeatedly until the cost function is smaller than the predetermined value further includes recalculating the cost function after optimizing the synthesized image to re-optimize the reflectance parameters.

In one embodiment of the present invention, the method of rebuilding the 3D surface model further includes optimizing the depth parameter of the 3D position according to the optimized reflectance parameters until the cost function is smaller than the predetermined value.

In one embodiment of the present invention, the method of rebuilding the 3D surface model further includes repeatedly optimizing the reflectance parameters and the 3D position until the difference between the synthesized image and the real image is smaller than the predetermined value.

From another perspective, the present invention provides another method for rebuilding a 3D surface model that includes obtaining of a 3D position of an object according to a 3D structured light system. Additionally, the method builds a synthesized image according to a 3D position and the Phong model. Then, a plurality of first reflectance parameters in the Phong model are optimized to optimize the synthesized image until a cost function is smaller than a first predetermined value, and to optimize the first reflectance parameters to optimize the depth parameter of the 3D position until the cost function is smaller than a second predetermined value. Furthermore, the synthesized image is optimized according to the optimized 3D position and a BSSRDF model. Next, the second reflectance parameters of the BSSRDF model are optimized to optimize the synthesized image until the cost function is smaller than a third predetermined value. Also, the depth parameter of the 3D position is optimized according to the optimized second reflectance parameters until the cost function is smaller than a fourth predetermined value.

Herein, the cost function includes a first term and a second term. In addition, the first term corresponds to a square of a difference between an intensity of pixels in the synthesized image and an intensity of pixels in a real image. On the other hand, the second term corresponds to the difference between a depth of each of the pixels in the synthesized image and a depth of a plurality of corresponding peripheral pixels. The remaining details of another method of rebuilding the 3D surface model are the same as provided in the above embodiments, and thus not repeated herein.

The present invention provides a new optimizing equation, and utilizes the Phong model and the BSSRDF model to perform image rebuilding with the consideration of the properties of specular scattering and subsurface scattering of an object. Therefore, the present invention does not require coating the object surface with paint or covering the object surface with lime prior to scanning. In addition, expensive instruments are not needed to acquire the more accurate geometric information provided by a non-lambertian and the subsurface scattering object.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a method of rebuilding a 3D surface model of an object according to one embodiment of the present invention.

FIG. 2 is a flow chart of a method of rebuilding a 3D surface model of an object according to another embodiment of the present invention.

### DESCRIPTION OF EMBODIMENTS

### First Embodiment

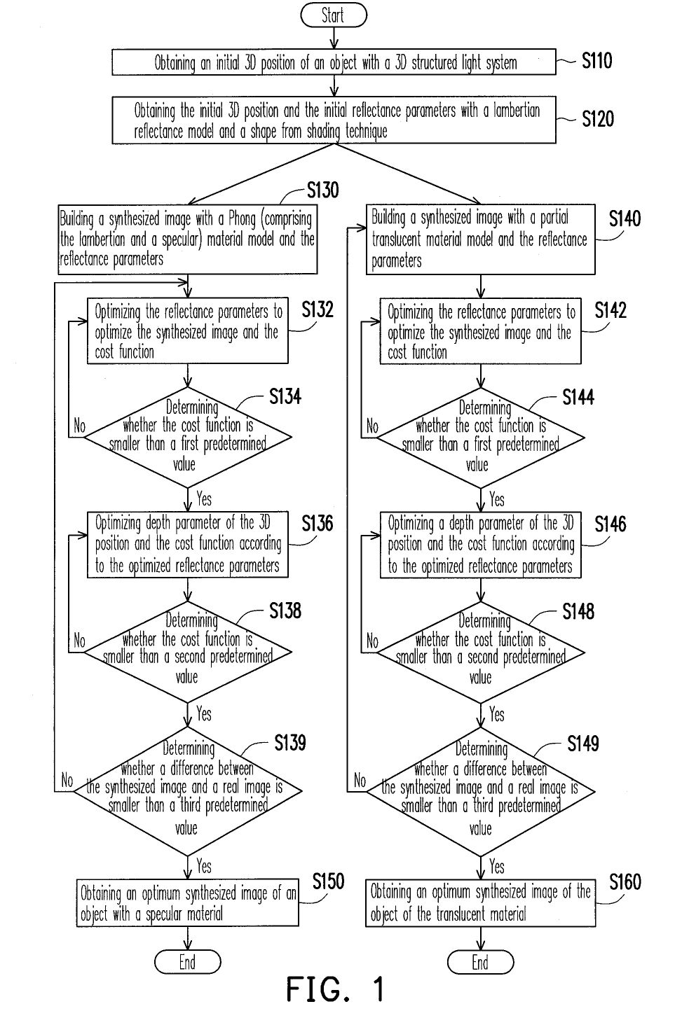

FIG. 1 is a flow chart a method of rebuilding a 3D surface model of an object according to one embodiment of the present invention. Referring to FIG. 1, first, as described by step S110, an initial 3D position (or initial 3D positions) of an object is acquired using a 3D structured light system, and a shading information of the object in the real scene, a camera position, and a light position are also acquired. Then, as described in step S120, initial values of a synthesized 3D position and reflectance parameters are acquired through a shape from shading technique and a lambertian reflectance model. The acquired reflectance parameters may be, for example, a pixel position and initial reflectance parameter values thereof (such as a scattering coefficient and a surface normal vector thereof), an intensity, or an image depth.

Next, an appropriate model is used to synthesize the image depending on the material property of the part of the object that the user desires to synthesize. For example, in step S130, a Phong material model used is suitable for objects containing specular components such as silver plates, and the above-mentioned Phong material model includes the lambertian model and a specular model. In addition, as for translucent materials such as rice, bread, marble and skin, a translucent material model described in step S140 is needed to build the synthesized image. The following description uses models containing the specular and the scattering materials as examples to establish the process of synthesizing the image and optimizing the synthesized image. As for the object mixed with different materials, then, an imaging model (such as the specular material model) is first applied for optimization, and another imaging model (such as a translucent material model) is thereat utilized for optimizing of a partial image.

As described in step S130, the synthesized image is built with the specular material model and the reflectance parameters. In the present embodiment, the specular material model in the Phong model (regarding Phong model, please refer to B. T. Phong, Illumination for computer generated pictures, Communications of the ACM, vol. 18, no. 8, p 311-317, 1975) is used to synthesize the images. The equation of the Phong model is represented as:

Sᵢ=k_{d}*Nᵢ·L+kₛ*(Fᵢ·V)^{α}

Herein, Sᵢ is a pixel intensity; k_{d} is a scattering coefficient; kₛ is a specular coefficient; Nᵢ is a point surface normal vector, which may be acquired by a slope of an adjacent zᵢ; zᵢ represents a depth of pixels of the synthesized image; L is an incident light vector, Fᵢ is a total specular reflection vector, which is acquired through Nᵢ and L; V is a viewing angle vector; α is a shininess coefficient.

However, the specular coefficient k_{d}, the scattering coefficient kₛ, and the shininess coefficient α are reflectance parameters P_{M} of the Phong model. Therefore, from the specular coefficient k_{d} and the scattering coefficient kₛ, the Phong model can be understood clearly as a non-lambertian model that considers the scattering and the specular properties of the object when synthesizing the 3D image. As a consequence, the specular reflection property of the detail parts in the image may be represented on the synthesized 3D images simulated by the Phong model, and thus further increases the verisimilitude of the synthesized 3D image. The image synthesized by the Phong model is represented as:

Tⁱ=<pₓⁱ, p_{y}ⁱ, Sⁱ>

Herein, Sⁱ is the pixel intensity of the synthesized image, and the value of Sⁱ is related to the reflectance parameters P_{M} of the reflection model, where the P_{M} is related to the specular coefficient k_{d}, the scattering coefficient kₛ, and the shininess coefficient α; x and y represent the horizontal and vertical coordinates and are used to label the pixel position in the image; and i represents a index value of the pixel. After obtaining the synthesized image, assuming the real image to be Oⁱ, the real image may be represented as:

Oⁱ=<pₓⁱ, pₓⁱ, Rⁱ>

Herein, Rⁱ is an intensity of a plurality of pixels of a real image, then the cost function C(Z) may be defined and represented as:

$$C ( z ) = {\sum }_{i = 1}^{n} {error ( {T}^{i} , {O}^{i} )}^{2}$$

Herein, error (Tⁱ, Oⁱ) is a difference between the synthesized image Tⁱ and the real image Oⁱ, and thus error (Tⁱ, Oⁱ) also represent the difference in the pixel intensity between the two images, error (Tⁱ, Oⁱ)=(Sⁱ−Rⁱ) Thus, the cost function C(Z) is otherwise represented as:

$$C = {\sum }_{i = 1}^{n} {error ( {T}^{i} , {O}^{i} )}^{2} = {\sum }_{i = 1}^{n} {( {S}^{i} - {R}^{i} )}^{2}$$

Besides, in order to increase the continuity of the synthesized image of the object, a smooth term is added to the cost function C(Z):

$$C ( Z ) = {\sum }_{i = 1}^{n} [ {( {S}^{i} - {R}^{i} )}^{2} + {\sum }_{j = 1}^{m} {( {r}_{j} - {z}_{i} )}^{2} ]$$

As a consequence, the cost function C(Z) includes a first term and a second term, of which the first term corresponds to a square of a difference between Sⁱ, an intensity of a plurality of pixels of a synthesized image, and Rⁱ, an intensity of a plurality of pixels of a real image Oⁱ. On the other hand, the second term corresponds to a difference between a depth of every pixel of a synthesized image, and a depth of a plurality of corresponding peripheral pixels.

Regarding the aforementioned cost function C(Z), Zᵢ represents the depth of the synthesized image; rⱼ represents the depth of a plurality of peripheral pixels relative to zᵢ; n represents a total pixel number in the synthesized image; m represent a total number of peripheral pixels; i corresponds to the pixels of the synthesized image; j corresponds to the peripheral pixels.

Next, in step S132, the reflectance parameters P_{M} are optimized, including the specular coefficient k_{d}, the scattering coefficient kₛ, and the shininess coefficient α, to optimize the synthesized image and the cost function C(Z). Then, it is determined whether the cost function C(Z) is smaller than a first predetermined value (step S134). In the case where the cost function C(Z) is larger than the first predetermined value, then the step S132 is repeated to optimize the reflectance parameters P_{M} continually. In case that the cost function C(Z) is smaller than the first predetermined value, then the reflectance parameters P_{M} are confirmed as optimal. Then, step S136 proceeds, and the 3D position depth parameter and the cost function C(Z) are optimized according to the optimum reflectance parameters P_{M}. Next, in step S318, the cost function is determined as to whether the cost function is smaller than a second predetermined value. In case that the cost function is not smaller than the second predetermined value, then the step S136 is repeated, and the depth parameter is optimized continually. In case the cost function is smaller than the second predetermined value, then the depth parameter is confirmed as optimal. Then, step S139 proceeds to determine whether the difference between the synthesized image and the real image is smaller than a third predetermined value. In case the difference is smaller than the third predetermined value, then the optimum synthesized image of the object with the specular material is acquired (step S150). In case that the difference between the synthesized image and the real image is not smaller than the third predetermined value, then the step S132 is reverted to repetitively optimize the reflection coefficient and the pixel depth of the Phong model until the difference between the synthesized image and the real image is smaller than the third predetermined value.

Also, in the above steps, in the optimizing process of obtaining the optimum reflectance parameters P_{M} and the depth parameter, the optimizing concept of the cost function C(Z) is to render the synthesized image more similar to the real image by optimizing the reflectance parameters P_{M} and the depth parameter. Therefore, the desired cost function C(Z) is the smaller the better. However, as the verisimilitude of the synthesized image increases, the optimizing time required is prolonged correspondingly. Thus, artisans in the arts pertinent to the field of the present invention may set the first predetermined value, the second predetermined value, and the third predetermined value according to their requirement level of the synthesized image verisimilitude and the speed of synthesizing images.

As for the optimum reflectance parameters P_{M} and the depth parameter, a Broyden-Fletcher-Goldfarb-Shanno (BFGS) can used to acquire the solution for the cost function C(Z). The BFGS method is a quasi-Newton Method, and is one of the most widely used variable metric methods. The BFGS method is mainly divided into several steps, first, an initial point and an initial matrix are acquired. Then, the partial differential of the target matrix is calculated to acquire the gradient vector. In case the calculated value is less than the predetermined precision requirement, then the solution is the optimum solution and the calculation is ended. In the event that the calculated requirement is not smaller than the predetermined precision value, then directions are searched with calculations to acquire the optimum solution sequentially. Please refer to Applied Optimization with MATLAB Programming, P. Ventakaraman, Wiley InterScience for the details regarding the calculation method of the BFGS method.

Using the BFGS method, in the present embodiment, the partial differential of C(Z) is calculated for the reflectance parameters P_{M} and the depth parameter of the optimum solution, of which a calculation equation is:

$$\begin{matrix}\frac{δ C ( Z )}{δ ( {P}_{M} )} = \frac{{\sum }_{i = 1}^{n} error {( {T}^{i} , {O}^{i} )}^{2}}{δ ( {P}_{M} )} \\ = 2 {\sum }_{i = 1}^{n} error ( {T}^{i} , {O}^{i} ) \cdot \frac{δ error ( {T}^{i} , {O}^{i} )}{σ ( {P}_{M} )}\end{matrix}$$

The reflectance parameters P_{M} and the depth parameter that meet the requirement of the users are acquired, and consequently the optimum synthesized image of the object with specular material is acquired. Notably, the present invention not only utilizes the BFGS method to calculate the optimum solution, other methods, such as a conjugate gradient, may also be applied in this issue.

Additionally, where a portion of the synthesized object is of a partial translucent material, a partial translucent material model can be chosen to optimize the image, as in steps S140˜S160. First, the partial translucent model is used to build the synthesized image Tⁱ (step S140):

Tⁱ=<pₓⁱ, pₓⁱ, Sⁱ>

The partial translucent model in the present embodiment may be, for example, the Bidirectional subsurface scattering reflection distribution function (BSSRDF) model (regarding the BSSRDF model, refer to H. Jensen, S. Marschner, M. Levoy, and P. Hanrahan, “A Practical Model for Subsurface Light Transport”, Proceedings of SIGGRAPH, pages 511-518, 2001). Herein, the equation of the BSSRDF model is as follows:

$${S}_{d} ( {x}_{i} , {\vec{ω}}_{i} , {x}_{o} , {\vec{ω}}_{o} ) = \frac{1}{π} {F}_{t} ( {x}_{i} , {\vec{ω}}_{i} ) {P}_{d} ( {‖ {x}_{i} - {x}_{o} ‖}_{2} ) {F}_{t} ( {x}_{o} , {\vec{ω}}_{o} )$$

Herein, S_{d} is the pixel intensity; Fₜ is a Fresnel transmittance; xᵢ is an incident position of a light entering an object; xₒ is a refractive position of a light leaving an object; \vec{ω}ᵢ is an incident angle; \vec{ω}ₒ is a refractive angle; P_{d} is a scattering quantitative change curve function. In the present embodiment, the concept of diffusion dipole (R_{d}) proposed in the study of “A Practical Model for Subsurface Light Transport” from Proceedings of ACM SIGGRAPH'01 by H. W. Jensen, S. R. Marschner, M. Levoy and P. Hanrahan is referred to approximate the function of P_{d} and save calculation time.

$${R}_{d} ( r ) = \frac{{α}^{′} {z}_{r} ( 1 + {σ}_{tr} {d}_{r , i} ) {e}^{- {σ}_{tr} {d}_{r}}}{4 π {d}_{r}^{3}} - \frac{{α}^{′} {z}_{v} ( 1 + {σ}_{tr} {d}_{v , i} ) {e}^{- {σ}_{tr} {d}_{v}}}{4 π {d}_{v}^{3}}$$

Herein, σₜᵣ=\sqrt{3σₐσ′ₜ} is an effective transport coefficient; at σ′ₜ=σₐ+σ is a reduced extinction coefficient; σₐ and σ′ₛ are an absorption coefficient and a scattering coefficient respectively. r=∥xₒ−xᵢ∥, dᵥ=\sqrt{r²+zᵥ²} and dᵣ=\sqrt{r²+zᵣ²} are the impact force of the point that provides surface magnetic force to the object and is affected by the dipoles; Zᵣ=1/σ′ₜ is a positive correlation coefficient of a real light source (positive charge) to the object surface; Zᵥ=Zᵣ+4AD is a negative correlation coefficient of a virtual light source (negative charge) to the object surface;

$$D = \frac{1}{3 {σ}_{t}^{′}}$$

is a scattering constant, and it defines A=(1+F_{dr})/(1−F_{dr}), where F_{dr} is a scattering Fresnel reflectance of a scattering part. The following equation is used to approximate F_{dr}:

$${F}_{dr} ≅ \{ \begin{matrix}- 0.4399 + \frac{0.7099}{η} - \frac{0.3319}{{η}^{2}} + \frac{0.0636}{{η}^{3}} , η < 1 \\ - \frac{1.4399}{{η}^{2}} + \frac{0.7099}{η} + 0.6681 + 0.0636 η , η > 1\end{matrix}$$

Herein, η is an index of refraction of the material of the object. Finally, in the BSSRDF model, the reflectance parameter P_{M} required by the pixel depth Sⁱ for the synthesized partial translucent object is concluded to be: αₐ (absorption coefficient), σ′ₛ (scattering coefficient), η (index of refraction of the material). Therefore, from the aforementioned reflectance parameters P_{M}, it is understood more clearly that using the partial translucent model, such as the BSSRDF model, causes the partial translucent model of the synthesized image to further approximate the real image.

The following steps of the optimizing process S142˜S149 are similar to the steps S132˜S139 for synthesizing the specular material model. The main difference is that the models used are different and the optimized reflectance parameters are different. The optimizing process and the calculation principle are similar to the steps S132˜S139, and are thus omitted herein. After the optimizing process, the optimum synthesized image of the partial translucent material is acquired (step S160).

Besides, it should be noted that the optimizing procedure of the Phong model (the steps S132˜S139) and the BSSRDF model (the steps S132˜S139) may proceed repetitively to optimize images with a smaller predetermined value or a stricter standard so that the image is closer to the real image. Notably, the difference between the synthesized image and the real image is contrasted, whether the Phong model or the BSSRDF model is being used to build the synthesized image. In the event where the difference between the two images is larger than the predetermined value, then the optimizing process is repeated to build a more realistic synthesized image. In addition, as for objects containing a plurality of materials (such as a specular reflection material and a partial translucent material), then the two models can be applied sequentially to proceed with the optimization. First, the Phong model is utilized for the optimization, then the BSSRDF model is used to optimize, or vice versa. The present embodiment is not limited by the order of the optimization. The second embodiment is referred to for a more advanced illustration.

### Second Embodiment

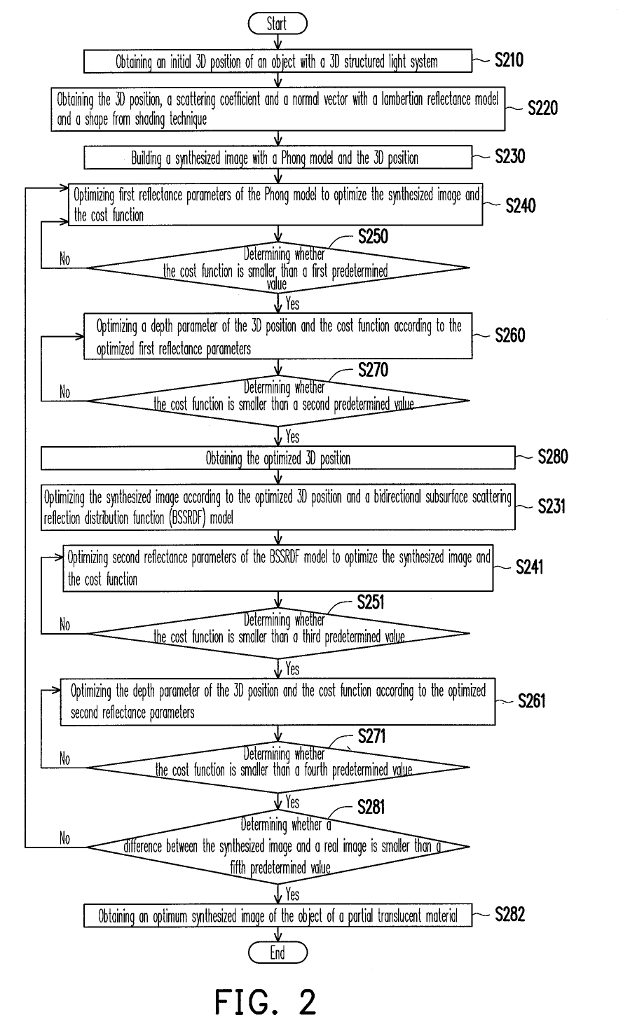

FIG. 2 is a flow chart of a method of rebuilding a 3D surface model of an object another embodiment of the present invention. Since the real object usually contains a specular part and a partial translucent part at the same time, comparing to the first embodiment, the second embodiment considers both the specular material part and the partial translucent part, and sequentially optimizes for the optimum synthesized image of the object. In should be noted that in different models, the reflectance parameters used to describe the object can represent different parameters, so as to discriminate the reflectance parameters to be optimized in different models. In the following descriptions, the present embodiment refers to the reflectance parameters (such as a specular coefficient kd, a scattering coefficient ks, and a shininess coefficient α) that are to be optimized in the Phong model as first reflectance parameters. The reflectance parameters (such as an absorption coefficient αₐ, a scattering coefficient σ′ₛ, and a refractive index η of the material) that are to be optimized in the BSSRDF model are referred to as second reflectance parameters.

First, in step S210, an initial 3D position of the object is acquired by a 3D structured light system. In the step S220, the initial values of the synthesized 3D position and the reflectance parameters are acquired by the shape from shading technique and the lambertian reflectance model. Next, in step S230, the specular material part of the object is synthesized by the 3D position and the Phong model to build the synthesized image. By the synthesized image and the real image, a cost function C(Z) may be defined as:

$$C ( Z ) = {\sum }_{i = 1}^{n} [ {( {S}^{i} - {R}^{i} )}^{2} + w {\sum }_{j = 1}^{m} {( {r}_{j} - {z}_{i} )}^{2} ]$$

The cost function is identical to the first embodiment, and thus the details are not repeated herein. Then, in step S240, the first reflectance parameters and the cost function C(Z) of the Phong model are optimized. The first reflectance parameters are the specular coefficient k_{d}, the scattering coefficient kₛ, and the shininess coefficient α. Next, in step S250, it is determined whether the cost function C(Z) is smaller a the first predetermined value. In the event that the cost function is not smaller than the first predetermined value, then the step S240 is repeated. In the event that the cost function is smaller than the first predetermined value, then the first reflectance parameters are confirmed to be optimal. Then, step S260 proceeds to optimize a depth parameter of the 3D position and the cost function C(Z) according to the optimized first reflectance parameters of the Phong model.

Then, in step S270, it is determined whether the cost function is smaller than a second predetermined value. In the event that the cost function is not smaller than the second predetermined value, then the step S260 is repeated. In the event that the cost function is smaller than the second predetermined value, then the depth parameter is confirmed to be optimal. Then, step S280 proceeds to acquire the synthesized image of the object with specular material by the optimum reflectance parameters and the optimum depth parameter acquired in the optimizing process aforementioned.

After optimizing the specular part of the object (as in the steps S210˜S280), the partial translucent part of the object is then optimized. In the step S231, the synthesized image is optimized according to the 3D position obtaining the specular property after optimization and the BSSRDF model. Then, in the step S241, the reflectance parameters in the BSSRDF model are optimized to optimize the synthesized image and the cost function. The reflectance parameters of the BSSRDF model are, for example, the absorption coefficient αₐ, the scattering coefficient σ′ₛ, and the refractive index η of the material.

Next, in step S251, it is determined whether the cost function C(Z) is smaller than a third predetermined value. In the event that the cost function is not smaller than the third predetermined value, then the step S250 is repeated to optimize the reflectance parameters in the BSSRDF model. In the event that the cost function is smaller than the third predetermined value, then the second reflectance parameters are confirmed to be optimal. Then, step S261 proceeds to optimize the depth parameter of the 3D position and the cost function C(Z) according to the optimum second reflectance parameters. After that, in step S271, it is determined whether the cost function C(Z) is smaller than a fourth predetermined value. In the event that the cost function is not smaller than the fourth predetermined value, then the step S261 is repeated to optimize the depth parameter. In the event that the cost function is smaller than the fourth predetermined value, then the depth parameter is confirmed to be optimal. Moreover, it is determined whether the difference between the synthesized image and the real image is smaller than a fifth predetermined value. In case that the difference is smaller than the fifth predetermined value, then the optimum second reflectance parameters and the optimum depth parameter acquired in the aforementioned optimizing process are used to acquire the synthesized image of the object with the specular material property and the partial translucent material property.

The first, second, third, and fourth predetermined values mainly correspond to the user's requirements of the synthesized image verisimilitude. The predetermined values may be modified based on the specifications required by the user, and are thus not limited by the present embodiment.

In summary, the present invention combines geometric information of the object acquired by the structured light system and the detailed geometric information acquired by the shape from shading technique, and applies the specular model and the partial translucent model to solve conventionally difficult issue by rebuilding the surface model of the object containing parts of the specular and the partial translucent materials. Other than rebuilding the 3D model of the object, the present invention also acquire the optimum reflectance parameter properties of the object, which greatly enhances the technological development of digitalization of real objects and computer visions. At the same time, the cost function of the present invention is capable of decreasing the time required for optimizing images and obtaining models and images of the object with high verisimilitude.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of rebuilding a three-dimensional (3D) surface model, comprising:
obtaining a 3D position of an object and a plurality of reflectance parameters corresponding to the object with a 3D structured light system;
building a synthesized image according to the 3D position and the reflectance parameters; and
optimizing the reflectance parameters to optimize the synthesized image until a cost function is smaller than a first predetermined value,
wherein the cost function corresponds to a difference between an intensity of a plurality of first pixels of the optimized synthesized image and an intensity of a plurality of second pixels of a real image.

2. The method of claim 1, wherein the cost function has a first term and a second term, wherein the first term corresponds to a square of the difference between the intensity of the first pixels of the synthesized image and the intensity of the second pixels of the real image, and the second term corresponds to the difference between a depth of each of the first pixels of the synthesized image and a depth of a plurality of corresponding peripheral pixels.

3. The method of claim 1, wherein the cost function has an equation as the following:
$$C ( Z ) = {\sum }_{i = 1}^{n} [ {( {S}^{i} - {R}^{i} )}^{2} + w {\sum }_{j = 1}^{m} {( {r}_{j} - {z}_{i} )}^{2} ]$$
wherein C(Z) represents the cost function; Sⁱ represents the intensity of the first pixels in the synthesized image; Rⁱ represents the intensity of the second pixels in the real image; zᵢ represents the depth of the first pixels in the synthesized image; rⱼ represents the depth of the plurality of peripheral pixels relative to zᵢ; n represents a total number of pixels in the synthesized image; m represents a total number of the plurality of peripheral pixels; i represents an index value of the pixels of the synthesized image; j represents an index value of the peripheral pixels; w represents a weight value.

4. The method of claim 1, wherein obtaining the 3D position of the object and the plurality of reflectance parameters corresponding to the object with the 3D structured light system further comprises:
obtaining initial values of the 3D position and the reflectance parameters of the object with a lambertian reflectance model and a shape from shading technique.

5. The method of claim 4, wherein the reflectance parameters comprise at least one of a scattering coefficient and a normal vector.

6. The method of claim 1, wherein building the synthesized image according to the 3D position and the reflectance parameters further comprises:
building the synthesized image with a specular material model and the reflectance parameters.

7. The method of claim 6, wherein the reflectance parameters comprise a scattering coefficient, a specular coefficient, and a shininess coefficient.

8. The method of claim 6, wherein the specular material model is a Phong model.

9. The method of claim 7, wherein the Phong model has an equation as the following:
Sᵢ=k_{d}*Nᵢ·L+kₛ*(Fᵢ·V)^{α}
wherein Sᵢ is a pixel intensity; k_{d} is a scattering coefficient; kₛ is a specular coefficient; Nᵢ is a point surface normal vector, acquired by a slope of an adjacent zᵢ; L is an incident light vector, Fᵢ is a total specular reflection vector, acquired by Nᵢ and L; V is a viewing angle vector; α is a shininess coefficient.

10. The method of claim 1, wherein building the synthesized image according to the 3D position and the reflectance parameters further comprises:
building the synthesized image with a partial translucent material model and the reflectance parameters.

11. The method of claim 10, wherein the reflectance parameters comprises a scattering coefficient, an absorption coefficient, and a refractive index.

12. The method of claim 10, wherein the partial translucent material model is a bidirectional subsurface scattering reflection distribution function (BSSRDF) model.

13. The method of claim 12, wherein the BSSRDF model has an equation as the following:
$${S}_{d} ( {x}_{i} , {\vec{ω}}_{i} , {x}_{o} , {\vec{ω}}_{o} ) = \frac{1}{π} {F}_{t} ( {x}_{i} , {\vec{ω}}_{i} ) {P}_{d} ( {‖ {x}_{i} - {x}_{o} ‖}_{2} ) {F}_{t} ( {x}_{o} , {\vec{ω}}_{o} )$$
wherein S_{d} is a pixel intensity; Fₜ is a Fresnel conversion function; xᵢ is an incident position where a light enters an object; xₒ is a refractive position where the light leaves an object; \vec{ωₜ} is an incident angle; \vec{ωₒ} is a refractive angle; P_{d} is a scattering quantitative change curve function.

14. The method of claim 1, wherein optimizing the reflectance parameters to optimize the synthesized image until the cost function is smaller than the first predetermined value further comprises:
re-calculating the cost function according to the optimized synthesized image to re-optimize the reflectance parameters.

15. The method of claim 1, further comprising:
optimizing a depth parameter of the 3D position according to the optimized reflectance parameters until the cost function is smaller than a second predetermined value.

16. The method according to claim 1, further comprising:
optimizing repeatedly the reflectance parameters and the 3D position until a difference between the synthesized image and the real image is smaller than a third predetermined value.

17. A method of rebuilding a 3D surface model, comprising:
obtaining a 3D position of an object with a 3D structured light system;
building a synthesized image according to the 3D position and a Phong model;
optimizing a plurality of first reflectance parameters in the Phong model to optimize the synthesized image until a cost function is smaller than a first predetermined value;
optimizing a depth parameter of the 3D position according to the optimized first reflectance parameters until the cost function is smaller than a second predetermined value;
optimizing the synthesized image according to the optimized 3D position and a BSSRDF model;
optimizing a plurality of second reflectance parameters of the BSSRDF model to optimize the synthesized image until the cost function is smaller than a third predetermined value; and
optimizing the depth parameter of the 3D position according to the optimized second reflectance parameters until the cost function is smaller than a fourth predetermined value,
wherein the cost function comprises a first term and a second term, wherein the first term corresponds to a square of a difference between an intensity of a plurality of first pixels of the synthesized image and an intensity of the plurality of second pixels of a real image, and the second term corresponds to a difference between a depth of each of the first pixels of the synthesized image and a depth of a plurality of corresponding peripheral pixels.

18. The method of claim 17, wherein the cost function has an equation as the following:
$$C ( Z ) = {\sum }_{i = 1}^{n} [ {( {S}^{i} - {R}^{i} )}^{2} + w {\sum }_{j = 1}^{m} {( {r}_{j} - {z}_{i} )}^{2} ]$$
wherein C(Z) represents the cost function; Sⁱ represents the intensity of the first pixels in the synthesized image; Rⁱ represents the intensity of the second pixels in the real image; Zᵢ represents the depth of the first pixels in the synthesized image; rⱼ represents the depth of the plurality of peripheral pixels relative to zᵢ; n represents a total number of pixels in the synthesized image; m represents a total number of the peripheral pixels; i represents an index value of the pixels of the synthesized image; j represents an index value of the peripheral pixels; w represents a weight value.

19. The method of claim 17, wherein obtaining the 3D position of the object with the 3D structured light system further comprises:
obtaining the 3D position, a scattering coefficient, and a normal vector of the object with a lambertian reflectance model and a shape from shading technique.

20. The method of claim 17, wherein the first reflectance parameters comprise a scattering coefficient, a specular coefficient, and a shininess coefficient.

21. The method of claim 17, wherein the Phong model has an equation as the following:
Sᵢ=k_{d}*Nᵢ·L+kₛ*(Fᵢ·V)^{α}
wherein Sᵢ is a pixel intensity; k_{d} is a scattering coefficient; kₛ is a specular coefficient; Nᵢ is a point surface normal vector, acquired by a slope of an adjacent zᵢ; L is an incident light vector, Fᵢ is a total specular reflection vector, acquired by Nᵢ and L; V is a viewing angle vector; α is a shininess coefficient.

22. The method of claim 17, wherein the second reflectance parameters comprise a scattering coefficient, an absorption coefficient, and a refractive index.

23. The method of claim 17, wherein the BSSRDF model has an equation as the following:
$${S}_{d} ( {x}_{i} , {\vec{ω}}_{i} , {x}_{o} , {\vec{ω}}_{o} ) = \frac{1}{π} {F}_{t} ( {x}_{i} , {\vec{ω}}_{i} ) {P}_{d} ( {‖ {x}_{i} - {x}_{o} ‖}_{2} ) {F}_{t} ( {x}_{o} , {\vec{ω}}_{o} )$$
wherein S_{d} is a pixel intensity; Fₜ is a Fresnel conversion function; xᵢ is an incident position where a light enters an object; xₒ is a refractive position where a light leaves an object; \vec{ωᵢ} is an incident angle; \vec{ωₒ} is a refractive angle; P_{d} is a scattering quantitative change curve function.

24. The method of claim 17, further comprising:
optimizing the first reflectance parameters, the second reflectance parameters, the depth parameter, and the 3D position until a difference between the synthesized image and the real image is smaller than a fifth predetermined value.
